(19) United States
(12) Patent Application Publication
(10) Pub. No.: US 2011/0037698 A1
(43) Pub. Date: Feb. 17, 2011

(54) Finger Mouse for Inputting Coordinate on Display Screen of Station

(76) Inventor: Sung Su Kim, Seoul (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/746,982

(22) PCT Filed: Dec. 10, 2008
(86) PCT No.: PCT/KR08/07289

§ 371 Date: Sep. 8, 2010

(30) Foreign Application Priority Data
Dec. 10, 2007 (KR) 10-2007-0127423
Dec. 8, 2008 (KR) 10-2008-0124077

(51) Int. Cl. G09G 5/08

(52) U.S. Cl. 345/163

(57) ABSTRACT

The present invention relates to a coordinate input device that enables coordinates to be input onto the display screens of various types of terminals, such as portable information terminals, through an operation of scrubbing or rubbing two opposite flat plates that are so small that they can be held between two fingers such as the thumb and the index finger or between three fingers, so that it can be easily and stably used even in an extremely restrictive environment such as a narrow space or a mobile situation. The finger mouse-type coordinate input device according to the present invention can detect a signal corresponding to the vertical movement or lateral rotation of two opposite flat plates in response to the application of a drive signal.

### TECHNICAL FIELD

The present invention relates generally to a device for inputting coordinates on the display screen of a portable information terminal, a desktop Personal Computer (PC) or a notebook PC, and, more particularly, to a coordinate input device that enables coordinates to be input onto the display screens of various types of terminals, such as portable information terminals, through an operation of scrubbing or rubbing two opposite flat plates that are so small that they can be held between two fingers such as the thumb and the index finger or between three fingers, so that it can be easily and stably used even in an extremely restrictive environment such as a narrow space or a mobile situation.

### BACKGROUND ART

Keyboards and mice are widely used to input coordinates at which cursors are located on the display screens of a portable information terminal, a desktop PC and a notebook PC. These coordinate input devices can be used for desktop or notebook PCs, but it is difficult to use them for small portable terminals, such as mobile phones and Personal Digital Assistants (PDAs), because the sizes thereof are large and they have difficulty with the operation thereof. That is, it is very inconvenient for a user to find the arrow of a keyboard connected to a portable terminal and then input location coordinates or to move a mouse connected to a portable terminal across a flat pad and then input location coordinates while moving by subway or bus, driving a private vehicle or walking.

Additionally, there are cases where joysticks are used. However, since this coordinate input device employs a method of detecting the inclination and direction of a post vertically erected on a flat surface, the size of the device is large, so that it does not provide a method capable of inputting location coordinates through its natural operation in a mobile environment.

In order to improve the method of inputting location coordinates, a method of detecting the location of a finger or dedicated pen, like that used in a touch screen, a touch panel or a tablet, has been developed. However, these location coordinate input devices require high costs for the manufacture of detection panels so as to achieve a precise location detection method, and do not enable location coordinates to be simply input using only two or three fingers.

### DISCLOSURE

### Technical Problem

Accordingly, the present invention has been made keeping in mind the above problems occurring in the prior art, and an object of the present invention is to provide a finger mouse-type coordinate input device that enables coordinates to be simply input based on relative vertical movement and inclination through an operation of scrubbing or rubbing two opposite flat plates that are so small that they can be held between two fingers such as the thumb and the index finger or between three fingers so as to easily and stably input the location coordinates of a cursor onto the display screen of a terminal.

Another object of the present invention is to provide a finger mouse-type coordinate input device that enables coordinates to be easily and stably input onto the display screens of various types of terminals such as an information terminal even in an extremely restrictive environment such as a narrow space or a mobile situation.

### Technical Solution

First, in summary, in order to accomplish the above objects, the present invention provides a finger mouse-type coordinate input device for detecting an electrical signal corresponding to relative vertical movement or lateral rotation of two opposite flat plates in response to application of a drive signal.

The two flat plates may include a first flat plate provided with parallel resisters and a second conductive flat plate configured to be brought into contact with the resisters and to be moved, and drive signals may be sequentially applied to both ends of at least one of the resisters and then a location signal corresponding to a moving location of the second conductive flat plate is detected.

The location signal may be input to a terminal including display means, and be used as the coordinates of a cursor displayed on a screen.

The location signal may be transmitted to the terminal via a wireless or wired connection.

According to another aspect of the present invention, there is provided a coordinate input device, including a coupling support configured to have a reception recess in a rotating element that is narrower than a base and is disposed on the base; a parallel resister board configured to have parallel resisters and be disposed on a surface around the reception recess of the rotating element; a cross conductor board disposed on the parallel resister board; and a lever configured such that a protrusion passes through central holes of the cross conductor board and the parallel resister board and is engaged with the reception recess and configured to have a predetermined flat surface.

According to still another aspect of the present invention, there is provided a coordinate input device, including a parallel resister board configured to have parallel resisters oriented upward or downward; a cross conductor board disposed in contact with the resisters over or under the parallel resister board; and a lever configured such that a protrusion sequentially passes through central holes of the parallel resister board and the cross conductor board and is engaged with the parallel resister board and the cross conductor board, and configured to have a predetermined flat surface.

When the lever is moved vertically or rotated laterally, the cross conductor board may be brought into contact with the resistors of the parallel resister board and be moved.

The coordinate input device may further include a location detection circuit for detecting a moving location of the cross conductor board with respect to the parallel resisters of the parallel resister board.

When DC or AC drive signals are sequentially applied to both ends of at least one of the resisters, the location detection circuit may detect a location signal corresponding to the moving location using a signal from the cross conductor board in contact with the resisters.

The location detection circuit may include a selection circuit for sequentially selecting a path for both ends of the at least one resistor at predetermined time intervals and applying the drive signal to the selected path.

The location detection circuit may apply DC or AC drive signals to the cross conductor board in contact with the resisters, and detect a location signal corresponding to the moving location using signals sequentially output from both ends of at least one or the resisters.

The location detection circuit may include a selection circuit for sequentially selecting signals output from both ends of the at least one resistor at predetermined time intervals and outputting a selected signal to a single path.

The location detection circuit may include an amplification circuit for amplifying signals from both ends of the resisters or the cross conductor board.

The location detection circuit may include an AD converter for creating a digital signal by converting the output of the amplification circuit in an analog to digital manner.

When a left, right or center of the lever is pressed, a click function including movement of a cursor, selection of content, scrolling, or provision or selection of a menu on a terminal may be performed in conjunction with the terminal.

The coordinate input device may further include a keypad disposed on an upper surface of the lever or at a predetermined location in a casing in which the coordinate input device is mounted, and the keypad may include a plurality of keys for inputting predetermined key values to a terminal.

According to still another aspect of the present invention, there is provided a coordinate input device including first detection means comprising first and second passive elements formed in parallel on a flat plate; and second detection means comprising a flat plate-shaped conductor in contact between both ends of the first passive element and both ends of the second passive element; wherein drive signals are sequentially applied to both ends of the first and second passive elements and then a signal is created by the second detection means that is moved vertically or rotated laterally between both ends of the first and second passive elements.

According to still another aspect of the present invention, there is provided a coordinate input device, further including a lower plate combined with a circuit board including an optical sensor; and an upper plate configured such that a protrusion is inserted into a guide recess or hole and is moved vertically or rotated laterally; wherein the optical sensor detects a signal corresponding to a moving location of the upper plate while radiating light onto a lower surface of the upper plate through a through hole of the lower plate.

The coordinate input device may further include a cross conductor board disposed in contact with the parallel resistors formed on an upper surface of the circuit board and configured to be moved as the upper plate is moved vertically or rotated laterally, the protrusion may be inserted into a guide recess or hole of the lower plate, and is then passed through and engaged with a central hole of the cross conductor board, and a drive signal may be applied to the optical sensor, the cross conductor board or the parallel resisters and then a signal corresponding to a moving location of the upper plate is detected.

A signal detected using the cross conductor board or the parallel resister may be used for correction of a signal detected using the optical sensor, and a signal detected using the optical sensor may be used for correction of a signal detected using the cross conductor board or the parallel resister.

### ADVANTAGEOUS EFFECTS

According to the finger mouse-type coordinate input device of the present invention, the location coordinates of a cursor can be easily and stably input simply based on relative vertical movement and inclination onto the display screen of a terminal through an operation of scrubbing or rubbing two opposite flat plates that are so small that they can be held between two fingers such as the thumb and the index finger or between three fingers.

Furthermore, according to the finger mouse-type coordinate input device of the present invention, coordinates can be easily and stably input onto the display screens of various types of terminals, such as a portable information terminal, even in an extremely restrictive environment such as a narrow space or a mobile situation.

### DESCRIPTION OF DRAWINGS

FIG. 1 is a diagram illustrating a finger mouse-type coordinate input device according to an embodiment of the present invention;

FIG. 2 is a diagram showing in detail the coupling support 110 of FIG. 1;

FIG. 3 is a diagram showing in detail the parallel resister board 120 of FIG. 1;

FIG. 4 is a diagram showing in detail the cross conductor board of FIG. 1;

FIG. 5 is a diagram showing in detail the lever of FIG. 1;

FIG. 6 is a diagram illustrating the vertical movement and lateral rotation of the cross conductor board according to an embodiment of the present invention;

FIG. 7 is a diagram illustrating a location detection sensor circuit according to an embodiment of the present invention;

FIG. 8 is a diagram illustrating a selector for inputting a signal to the location detection sensor circuit of FIG. 7;

FIG. 9 is a diagram illustrating a finger mouse-type coordinate input device according to another embodiment of the present invention;

FIG. 10 is a diagram illustrating the principle of the optical sensor of FIG. 9; and

FIG. 11 is a diagram illustrating a finger mouse-type coordinate input device according to another embodiment of the present invention.

### BEST MODE

Although preferred embodiments of the present invention will be described in detail below with reference to the attached drawings and the content described in the attached drawings, the present invention is not limited or restricted to these embodiments. Each of the same reference characters throughout respective drawings denotes the same element.

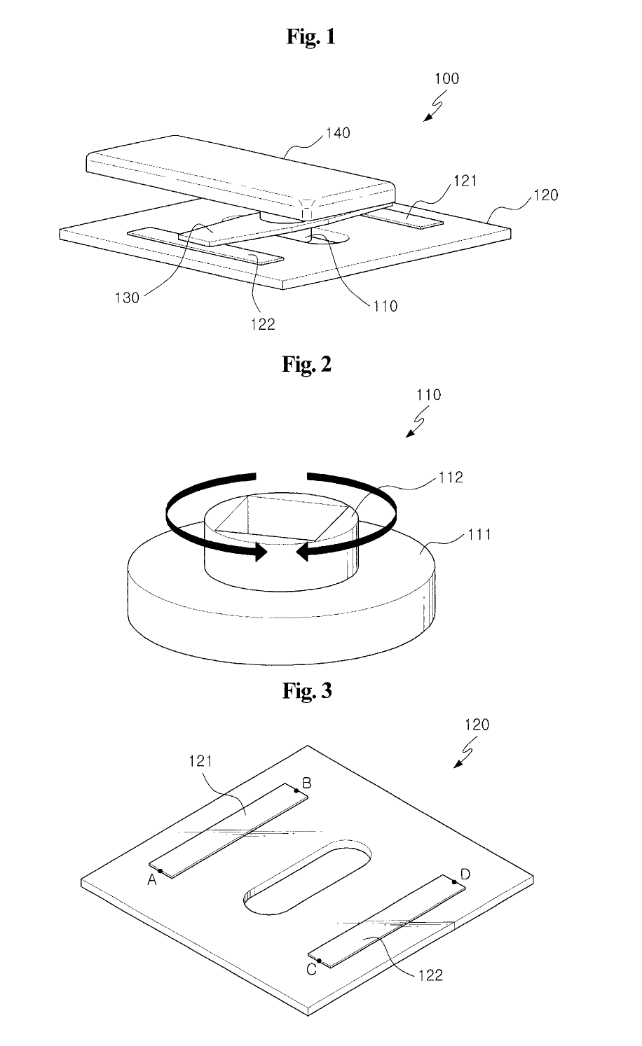

FIG. 1 is a diagram illustrating a finger mouse-type coordinate input device 100 according to an embodiment of the present invention. Referring to FIG. 1, the finger mouse-type coordinate input device 100 according to the embodiment of the present invention includes a coupling support 110, a parallel resister board 120 provided with parallel resisters 121 and 122 as first detection means, a cross conductor board 130 configured to be brought into contact with the resisters 121 and 122 and to move vertically and rotate laterally as second detection means, and a lever 140. Since the protrusion of the lever 140 is engaged with the reception recess of the coupling support 110, the parallel resister board 120 and the cross conductor board 130 are brought into contact with each other, and the cross conductor board 130 may be moved vertically between both ends of the central hole of the parallel resister board 120. Furthermore, since the rotating element of the coupling support 110 including the reception recess is rotated laterally, the cross conductor board 130 may be rotated on the parallel resister board 120.

In the finger mouse-type coordinate input device 100 according to the embodiment of the present invention, the cross conductor board 130, which is a conductor and has a flat plate shape, may be brought into contact with the resisters 121 and 122 and be moved on the flat plate-shaped parallel resister board 120 having the parallel resisters 121 and 122. The coordinate input device 100 can be formed to be so small that it can be held with two fingers, such as the thumb and the index finger, or three fingers. The two opposite flat plates 120 and 130 may be moved in contact with each other by scrubbing or rubbing the lever 140 with fingers.

In order to detect the location of the cross conductor board 130 based on an inclination attributable to the relative vertical movement or lateral rotation between the two flat plates 120 and 130 on the parallel resister board 120, using a predetermined location detection circuit, drive signals are sequentially applied to both ends of the resisters 121 and 122 and a signal corresponding to the moving location of the cross conductor board 130 can be detected.

The location signal created using a specific location detection circuit as described above is input to display means, and can be used as the coordinates of a cursor displayed on the screen. The location signal generated in the coordinate input device 100 as described above may be sent to the display means via a wired or wireless connection. For example, the coordinate input device 100 may be connected to a portable terminal via a cable, like a wired mouse. Accordingly, the coordinate input device 100 can receive signals necessary for the driving of the coordinate input device 100, such as a driving signal, from the terminal, and can send a location signal corresponding to the moving location of the cross conductor board 130 detected as described above to the terminal so that it can be used as the coordinates of a cursor displayed on the screen of the display means. Furthermore, the above-described drive signal used for the coordinate input device 100 or the location signal generated by the coordinate input device 100 may be sent and received using a short-distance wireless communication method such as Bluetooth or ZigBee.

As described above, the finger mouse-type coordinate input device 100 of the present invention can easily and stably input the location coordinates of a cursor simply based on relative vertical movement and inclination onto the display screen of a terminal through an operation of scrubbing or rubbing two opposite flat plates 120 and 130 that are so small that they can be held between two fingers such as the thumb and the index finger or between three fingers. As a result, by using the finger mouse-type coordinate input device 100 according to the present invention, coordinates can be easily and stably input onto the display screens of various types of terminals, such as portable information terminals, even in an extremely restrictive environment such as a narrow space or a moving situation.

The finger mouse-type coordinate input device 100 according to the present invention will be described in greater detail below with reference to FIGS. 2 to 8.

FIG. 2 is a diagram showing in detail the coupling support 110 of FIG. 1. Referring to FIG. 2, the coupling support 110 includes a base 111, and a rotating element 112 disposed on the base 111 and configured to have a shorter width (or diameter) than the base 111 and to have a reception recess. The rotating element 112 has the square reception recess for realizing engagement with the protrusion of the lever 140, and can be laterally rotated over the base 111. Here, the reception recess may have one of various polygonal shapes, such as a circular shape, a triangular shape, a star shape, or other shapes which are not a square shape, and the rotating element 112 may be rotated by 360 degrees.

FIG. 3 is a diagram showing in detail the parallel resister board 120 of FIG. 1. Referring to FIG. 3, the parallel resister board 120 has the parallel resisters 121 and 122 at two opposite ends thereof with a central hole interposed therebetween, and is disposed on a surface around the reception recess of the rotating element 112 of the coupling support 110 so that the reception recess of the rotating element 112 of the coupling support 110 can be seen through the central hole. Accordingly, the parallel resister board 120 can move vertically on the rotating element 112 of the coupling support 110 between both ends of the central hole of the parallel resister board 120. The resisters 121 and 122 may be formed of a linear metal coating or a carbon coating so that both ends AB and CD of the resisters 121 and 122 have predetermined resistance values.

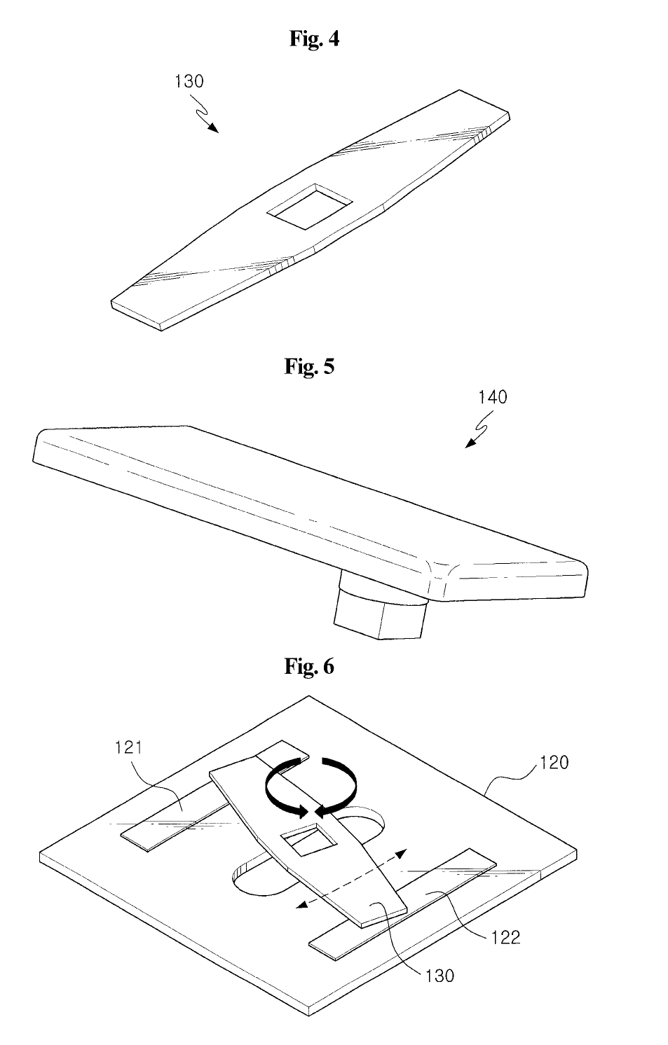

FIG. 4 is a diagram showing in detail the cross conductor board 130 of FIG. 1. Referring to FIG. 4, the cross conductor board 130 formed of a conductor such as copper is disposed on the parallel resister board 120 so that the reception recess of the rotating element 112 of the coupling support 110 can be seen through the central hole.

FIG. 5 is a diagram showing in detail the lever 140 of FIG. 1. Referring to FIG. 5, the lever 140 has a protrusion that can be engaged with the reception recess of the rotating element 112 of the coupling support 110, and the protrusion may be formed at an end of a specific plane so that it can be scrubbed or rubbed with fingers. The protrusion of the lever 140 is sequentially passed through the parallel resister board 120 and the cross conductor board 130 disposed on the rotating element 112 of the coupling support 110, and is then engaged with the reception recess of the rotating element 112. In the case where the protrusion of the lever 140 is engaged with the reception recess of the rotating element 112 of the coupling support 110, appropriate force must be applied both to the parallel resister board 120 and to the cross conductor board 130 through the engagement between the protrusion of the lever 140 and the reception recess of the rotating element 112 of the support 110 so that the parallel resister board 120 can be naturally slid on the rotating element 112 or the cross conductor board 130 can be laterally rotated using a small amount of force.

As a result, when the lever 140 is rubbed or scrubbed with the finger mouse-type coordinate input device 100 according to the present invention being held with two or three fingers, the lever 140 can be moved vertically and rotated laterally, with the result that the cross conductor board 130 under appropriate force based on the engaging force may be brought into contact with the resisters 121 and 122 of the parallel resister board 120 and be moved.

That is, since the square protrusion of the lever 140 is engaged with the square reception recess of the coupling support 110, the parallel resister board 120 and the cross conductor board 130 can be brought into contact with each other under appropriate force, and the cross conductor board 130 can be moved vertically between both ends of the central hole of the parallel resister board 120, as shown in FIG. 6. Furthermore, since the rotating element 112 of the coupling support 110 including the corresponding reception recess is laterally rotated, as shown in FIG. 6, the cross conductor board 130 can be laterally rotated on the parallel resister board 120.

Meanwhile, the coupling support 110 is not necessarily required. For example, a coordinate input device 100 such as that shown in FIG. 1 may be mounted inside a casing open at the top thereof. Here, in the case where a lever 140 projecting above the casing is configured to be scrubbed or rubbed with the fingers, combination is performed without the use of the coupling support 110 in such a way that the protrusion of the lever 140 is passed through the central holes of the parallel resister board 120 and the cross conductor board 130 and reaches a bottom surface, so that they can be combined together under specific force. Alternatively, a reception recess may be formed in the protrusion of the lever 140, and a specific pin may be upwardly passed through the parallel resister board 120 and the central hole of the cross conductor board 130 and be inserted into the reception recess of the protrusion.

Furthermore, although the lever 140, the cross conductor board 130 and the parallel resister board 120 may be combined together in the sequence of the lever 140, the cross conductor board 130 and the parallel resister board 120, as shown in FIG. 1, they may be combined together in the sequence of the lever 140, the parallel resister board 120 and the cross conductor board 130 so as to reduce the abrasion of the resisters 121 and 122. In this case, the resisters 121 and 122 of the parallel resister board 120 are oriented downward and the cross conductor board 130 is disposed under the parallel resistor board 120 and in contact with the resisters 121 and 122. The protrusion of the lever 140 for coupling them together is passed downward through the central holes of the parallel resister board 120 and the cross conductor board 130 and can be combined with the parallel resister board 120 and the cross conductor board 130 when under a predetermined amount of force.

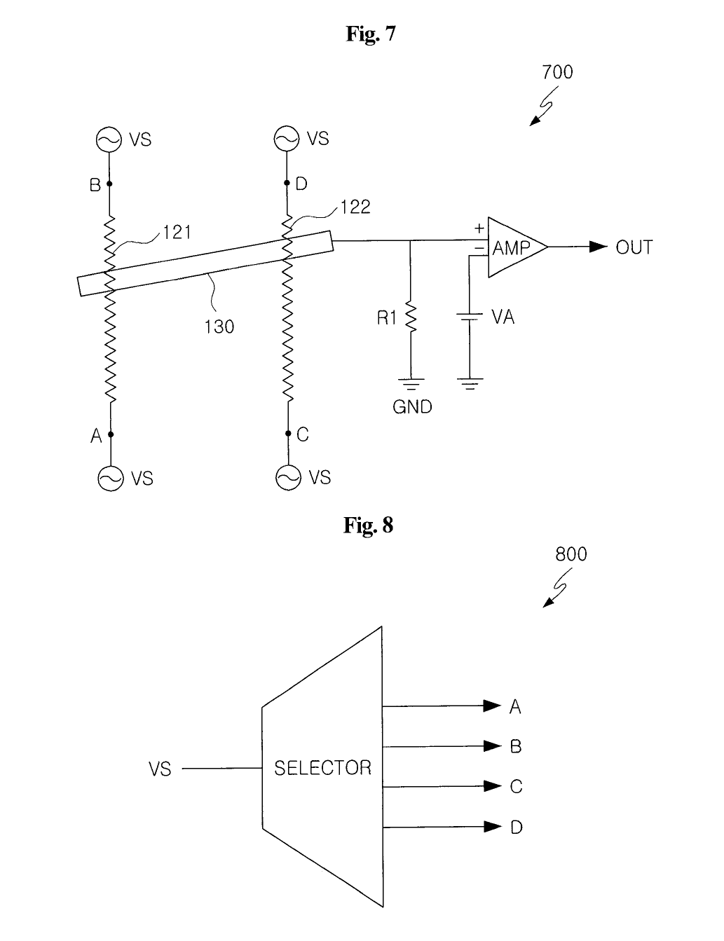

FIG. 7 is a diagram illustrating a location detection sensor circuit 700 according to an embodiment of the present invention. Referring to FIG. 7, the location detection sensor circuit 700 according to the embodiment of the present invention includes a resistor R1 and an amplifier AMP.

The location detection sensor circuit 700 detects the moving location of the cross conductor board 130 on the parallel resister board 120. For example, when drive signals VS are sequentially applied to both ends A, B, C and D of the resisters 121 and 122 on the parallel resister board 120, the location detection sensor circuit 700 can detect a location signal OUT corresponding to the moving location of the cross conductor board 130 using a signal from the cross conductor board 130 in contact with the resisters 121 and 122. Here, although such a drive signal VS may be an AC signal having a specific frequency, it is preferred that the drive signal VS be a DC voltage.

FIG. 8 is a diagram illustrating a selector 800 for inputting a drive signal VS to the location detection sensor circuit 700 of FIG. 7. Referring to FIG. 8, the selector 800 may be a demultiplexer-type circuit, and is configured to sequentially select paths to A, B, C and D of FIG. 7 at predetermined regular intervals of, for example, several msec and apply a drive signal VS to a selected path. It is preferable to set the paths other than a path to which a drive signal VS is applied to an open state, that is, a floating state, rather than a ground state, or set the paths to a high impedance state so as to prevent a noise-related antenna effect or prepare for EMI Electromagnetic Interference.

Accordingly, in the case where the cross conductor board 130 is moved vertically or is rotated laterally, the amplifier AMP creates a corresponding location signal OUT by amplifying a signal from the cross conductor board 130 that is brought into contact with the resisters 121 and 122.

For example, in the case where a drive signal VS, for example, a predetermined DC voltage, is applied to location A by the selector 800, the resistance between A and the contact point of the cross conductor board 130 distributes voltage to R1 and DC voltage using the cross conductor board 130 in contact between AB, with the result that the amplifier AMP amplifies voltage distributed to the resistor R1. Since the locations B, C and D are in an open state when the drive signal is applied to the location A, only the voltage of the location A influences the voltage distributed to the resistor R1 and the open states of the locations B, C and D do not influence the voltage distributed to the resistor R1. The amplifier AMP may be of a differential amplifier type. A specific DC voltage VA that is used to be compared with the voltage distributed to the resistor R1 may be applied to another input terminal of the amplifier AMP, and VA may be grounded depending on the circuit construction. Although not shown in FIG. 7, the location detection sensor circuit 700 may include an AD converter for creating a digital signal by converting the output OUT of the amplifier AMP in an analog-to-digital manner.

Meanwhile, the above-described operation of the amplifier AMP is repeated whenever a drive signal VS, for example, a specific DC voltage, is applied to each of the locations B, C and D. Accordingly, the output OUT of the amplifier AMP or the digital value of the output OUT may be sent to the processor of a terminal or the like, and may be used to create the location coordinates of a cursor that is displayed on display means, such as a Liquid Crystal Display (LCD), a Plasma Display Panel (PDP), or a cathode-ray tube, which is included in the terminal.

For example, in the case where the cross conductor board 130 is moved vertically by scrubbing or rubbing using the fingers, the cursor displayed on the display means may be processed so that it can be moved vertically across a screen. Furthermore, in the case where the cross conductor board 130 is rotated laterally by scrubbing or rubbing using the fingers, the cursor displayed on the display means may be processed so that it can be moved laterally in proportion to the inclination thereof. Since in FIG. 7, respective instantaneous drive signals VS are sequentially applied to the four locations A, B, C and D, the processor for processing the output OUT of the amplifier AMP or the digital value of the output OUT can calculate the location with which the cross conductor board 130 is brought into contact between the locations A and B, and can calculate the location with which the cross conductor board 130 comes into contact between the locations C and D. For example, the processor may provide a location on the display means based on a specific function for a location between the locations A and B the cross conductor board 130 or the location between the locations C and D.

The above-described location detection sensor circuit 700 may be mounted at an appropriate location in the finger mouse-type coordinate input device 100 according to the present invention such as a location below the parallel resister board 120 or the lever 140. Necessary circuits including the above-described selector 800 and AD converter may be included in the location detection sensor circuit 700 mounted in the coordinate input device 100. Furthermore, some circuits of the location detection sensor circuit 700 may be included in the terminal connected via a cable or wireless connection.

For example, in the case where the selector 800 is included in the location detection sensor circuit 700, at least a cable for receiving a drive signal VS from the terminal and also a cable for sending the detected location signal OUT or the digital value of the detected location signal OUT to the terminal are required between the terminal and the coordinate input device 100. Furthermore, in the case where the selector 800 is included in a specific processor of the terminal, at least cables for connecting the locations A, B, C and D to the terminal and a cable for sending the detected location signal OUT or the digital value of the location signal OUT to the terminal are required between the terminal and the coordinate input device 100.

In the case where the finger mouse-type coordinate input device 100 according to the present invention is of a wireless mouse type, the drive signal VS and the location signal OUT or the digital value of the location signal OUT may be sent and received between the terminal and the coordinate input device 100 using a short-distance wireless communication method such as Bluetooth or ZigBee.

Meanwhile, in FIG. 7, the location detection sensor circuit 700 may be operated using some other method. For example, a drive signal VS is applied to the cross conductor board 130 in contract with the resisters 111 and 112, and a location signal OUT corresponding to the moving location of the cross conductor board 130 may be detected using signals that are sequentially output from both ends of the resisters 111 and 112. For this purpose, it is necessary to, using a predetermined selection circuit such as a multiplexer circuit, sequentially select respective signals sequentially output from both ends A, B, C and D of the resisters 111 and 112 at the above predetermined time intervals, output such a signal to a single path, and connect the output of the selection circuit to one terminal (for example, + terminal) of the amplifier AMP, rather than connecting the cross conductor board 130 to one terminal (for example, + terminal) of the amplifier AMP, as in FIG. 7. In the case where this operation is performed, an effect similar to the effect of obtaining the location signal OUT can be obtained.

Although the examples of the location detection sensor circuit 700 have been described as described above, the present invention is not limited thereto. Every circuit capable of detecting an electrical signal corresponding to each of the vertical movement and lateral rotation between two opposite flat plates (for example, 120 and 130) in response to the application of a drive signal VS may be used as a circuit for detecting the location signal OUT. For example, an inclination may be detected using the sensor of an optical mouse or a rotating resistor, and the location of vertical movement may be detected using a normal sliding potentiometer.

### MODE FOR INVENTION

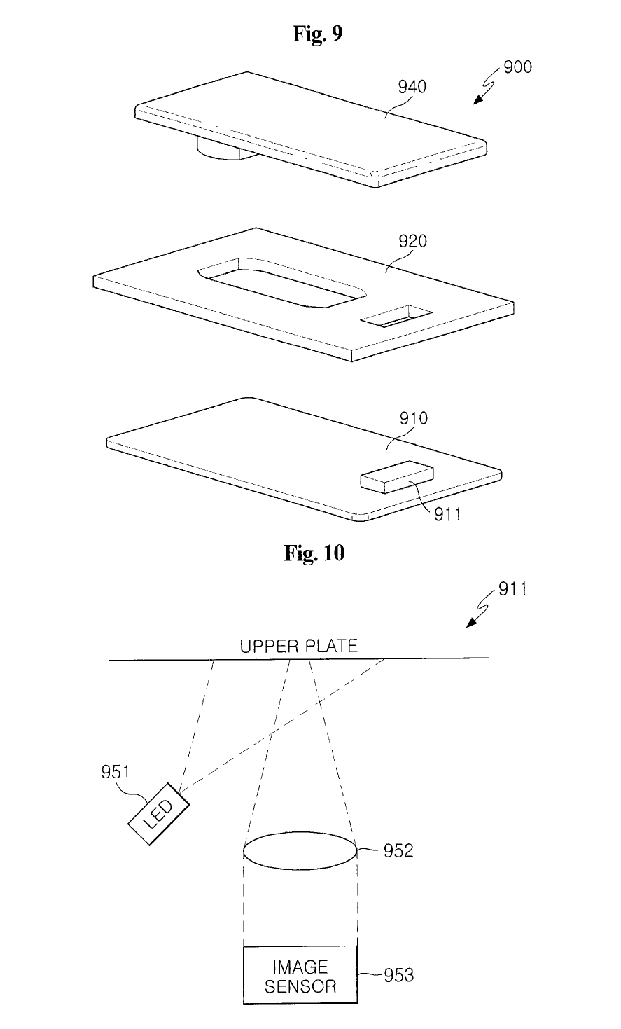

FIG. 9 is a diagram illustrating a finger mouse-type coordinate input device 900 according to another embodiment of the present invention.

Referring to FIG. 9, the finger mouse-type coordinate input device 900 according to the embodiment of the present invention includes a flat plate-shaped lower plate 920 combined with a circuit board 910 including an optical sensor 911, and a flat plate-shaped upper plate 940 configured such that the protrusion thereof formed to face the lower plate 920 is inserted into the guide recess or hole of the lower plate 920 and is moved vertically or rotated laterally. The upper plate 940 is used in the same way as the lever 140 of FIG. 1.

The size of the guide recess or hole of the lower plate 920 is greater than that of the protrusion of the upper plate 940. Accordingly, when the upper plate 940 is moved vertically or rotated laterally within the guide recess or hole of the lower plate 920 by scrubbing or rubbing using the fingers, the optical sensor 911 that operates in response to the application of a specific drive signal may detect a signal corresponding to the moving location of the upper plate 940, such as an image signal, while radiating light onto the lower surface of the upper plate 940 via the through hole of the lower plate 920.

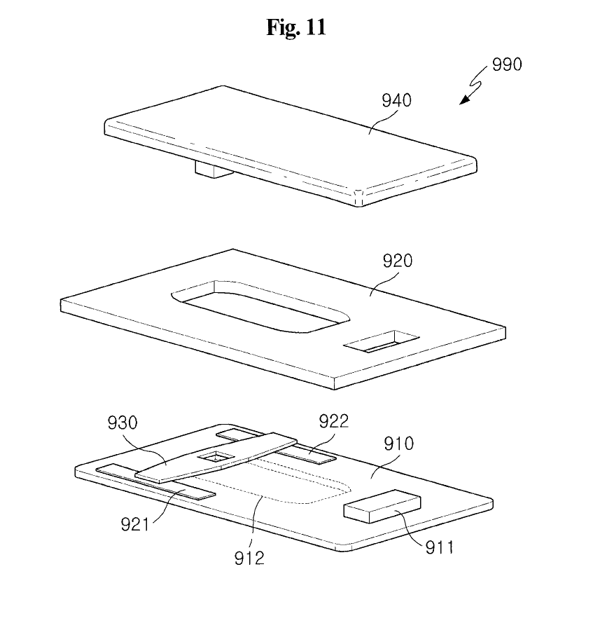

As shown in FIG. 10, the optical sensor 911 may include a Light Emission Diode (LED) module 951 for radiating light onto the upper plate 940, a lens 952 for collecting light from the upper plate 940, and an image sensor 953 for detecting an image that enters through the lens 952. Here, a laser generation module may be used instead of the LED module 951, and one of various image detection means, such as a Complementary Metal Oxide Semiconductor (CMOS)-type image sensor and a Charge Coupled Device (CCD)-type image sensor, may be used as the image sensor 953. When the upper plate 940 is moved, an image signal captured by the image sensor 953 may be sent to a processor provided in the circuit board 910 combined with the lower plate 920 or provided in a terminal, so that the corresponding processor can calculate a moving direction and distance by comparing the images captured before and after the movement with each other and can create the location coordinates of a cursor displayed on the display means, such as an LCD, a PDP or a cathode-ray tube, connected to the terminal.

FIG. 11 is a diagram illustrating a finger mouse-type coordinate input device 990 according to another embodiment of the present invention. The coordinate input device 990 of FIG. 11 has a structure in which the structure of FIG. 1 and the structure of FIG. 9 are combined with each other.

Referring to FIG. 11, the finger mouse-type coordinate input device 990 according to another embodiment of the present invention is similar to that of FIG. 9, but is configured such that parallel resisters 921 and 922 are formed on the upper surface of a circuit board 910 as in FIG. 1. Furthermore, the finger mouse-type coordinate input device includes a cross conductor board 930 that is disposed in contact with the parallel resisters 921 and 922. Here, a combination is performed in such a way that the protrusion of the upper plate 940 is inserted into the guide recess or hole of the lower plate 920 and is then passed through the central hole of the cross conductor board 930. In some cases, a guide recess or hole 912 capable of allowing the protrusion of the upper plate 940 to be moved vertically or rotated laterally may also be formed in the circuit board 910, in which case a coupling support 110, such as that shown in FIG. 1, may be used under the guide recess or hole of the circuit board 910. However, without the use of the coupling support 110, the cross conductor board 930 is brought into contact with the parallel resisters 921 and 922 and is fixedly attached to the upper plate 940, so that the cross conductor board 930 can also be moved at the same time that the upper plate 940 is moved vertically or rotated laterally. As a result, a more precise location signal can be created by combining a location signal based on the operation of the parallel resisters 921 and 922 and the cross conductor board 930 and a location signal based on the operation of the optical sensor 911 of FIG. 9 together.

For example, when the upper plate 940 is scrubbed or rubbed between fingers, the optical sensor 911 can detect a signal corresponding to the moving location of the upper plate 940, for example, an image signal, while radiating light onto the lower surface of the upper plate 940 through the through hole of the lower plate 920 in response to a corresponding drive signal, and can also apply a drive signal to the cross conductor board 930 or the parallel resisters 921 and 922 and detect a signal corresponding to the moving location of the upper plate 940, as shown in FIG. 7. According to the above-described operation, the corresponding location signal can be calculated using the signal detected by the optical sensor 911, or can be calculated by processing the signal generated by the cross conductor board 930 or parallel resisters 921 and 922. Furthermore, in order to more precisely calculate a location, the location signal calculated using the signal detected by the optical sensor 911 may be used for the correction of the location signal calculated using the cross conductor board 930 or parallel resisters 921 and 922, and vice versa.

As described above, each of the finger mouse-type coordinate input devices 100, 900 and 990 according to the present invention can easily and stably provide the location coordinates of a cursor on display means based on relative vertical movement and inclination onto the display screen of a terminal through an operation of scrubbing or rubbing the two opposite flat plates 120, 130/920 or 940 that are so small that they can be held between two fingers such as the thumb and the index finger or between three fingers, even in an extremely restrictive environment such as a narrow space or mobile situation.

The terminal described in the present invention is a small-sized portable information terminal. The terminal includes mobile terminals capable of communicating via the wireless or portable Internet, such as a cellular phone, a Personal Communications Services (PCS) phone and a synchronous/asynchronous International Mobile Telecommunication (IMT)-2000, and further includes all wireless/wired consumer electronic/communication devices including display means as user interfaces, such as a palm PC, a PDA, a smart phone, a Wireless Application Protocol (WAP) phone and a mobile game player. Of course, the terminal described in the present invention further includes a desktop PC and a notebook PC, and can be usefully used to provide the location of a cursor on corresponding display means according to each of the finger mouse-type coordinate input devices 100, 900 and 990 of the present invention.

With regard to the terminal, in general, in the case where a device for inputting the coordinates of a cursor, such as a mouse, is used, the mouse is provided with a click function or a predetermined keypad, so that the coordinate input device connected to the terminal enables simple information to be input, thereby providing more convenience to a user.

For this purpose, first, the lever 140 or upper plate 940 of the coordinate input device 100, 900 or 990 according to the present invention may perform a click function. For example, although not shown in the drawings, there may be a structure in which the lever 140 or upper plate 940 according to an embodiment of the present invention includes a plurality of layers, and a circuit board (for example, a Printed Circuit Board (PCB)) and the plurality of layers are combined together. As a result, when the left side, right side or center of the lever 140 or upper plate 940 is pressed and therefore a corresponding metal protrusion provided in the upper plate is brought into contact with the circuit board, a predetermined circuit is enabled to detect this, so that the lever 140 or upper plate 940 is enabled to perform a click function for the movement of a cursor across a terminal, the selection of content, scrolling, or the provision of a menu or the selection of menu options, in conjunction with the terminal. As a result, a right key function that is performed when the right side of the upper plate is pressed may be configured to display a predetermined menu for a corresponding application on a terminal screen, a left key function that is performed when the left side of the upper plate is pressed may be configured to move a cursor or select content or an option of the menu on the terminal screen, and a scroll function or some other predetermined function may be performed when the center is pressed, as in the typical mouse.

Furthermore, a keypad may be included at a location such as on the lever 140 of the coordinate input device 100, 900 or 990 according to the present invention, the upper (front) surface of the upper plate 940, or the rear surface of a casing in which the coordinate input device 100, 900 or 990 is mounted. The keypad may include a plurality of keys for inputting predetermined key values to a terminal, such as Arabic number keys, English letter keys, Korean letter keys, various symbol keys, arrow keys and function keys. As a result, in a situation in which it is difficult to use the keypad of a terminal, predetermined information can be easily input to the terminal using the keypad of the coordinate input device.

Although the present invention has been described above in conjunction with limited embodiments and drawings, the present invention is not limited to the embodiments, but those skilled in the art to which the present invention pertains can make various modifications and changes based on the above description. For example, although the case where resistors are formed in the parallel resister board 120 has been taken as an example, the present invention is not limited thereto. That is, it is possible to replace the resistors with various passive elements, such as capacitors, inductors or a combination thereof, or to change drive conditions. Therefore, the range of the present invention must not be defined only based on the above-described embodiments, but must be defined based on the equivalents of the following claims as well as the following claims.

1-23. (canceled)

24. A coordinate input device for detecting an electrical signal corresponding to relative vertical movement or lateral rotation of two opposite flat plates in response to application of a drive signal.

25. The coordinate input device according to claim 24, wherein:
the two flat plates comprise a first flat plate provided with parallel resistors and a second conductive flat plate configured to be brought into contact with the resistors and to be moved, and
drive signals are sequentially applied to both ends of at least one of the resistors and then a location signal corresponding to a moving location of the second conductive flat plate is detected.

26. The coordinate input device according to claim 25, wherein the location signal is input to a terminal including display means and is used as coordinates of a cursor displayed on a screen.

27. The coordinate input device according to claim 24, wherein:
the two flat plates comprise a first flat plate combined with an optical sensor and a second flat plate configured to have a flat surface for receiving light from the optical sensor, and
a signal corresponding to a moving location of the second flat plate is detected using light that is radiated by the optical sensor onto the flat surface.

28. A coordinate input device, comprising:
a parallel resistor board configured to have parallel resistors oriented upward or downward;
a cross conductor board disposed in contact with the resistors over or under the parallel resistor board; and
a lever configured such that a protrusion sequentially passes through central holes of the parallel resistor board and the cross conductor board and is engaged with the parallel resistor board and the cross conductor board, and configured to have a predetermined flat surface.

29. The coordinate input device according to claim 28, wherein, when the lever is moved vertically or rotated laterally, the cross conductor board is brought into contact with the resistors of the parallel resistor board and is moved.

30. The coordinate input device according to claim 28, further comprising a location detection circuit for detecting a moving location of the cross conductor board with respect to the parallel resistors of the parallel resistor board.

31. The coordinate input device according to claim 30, wherein the location detection circuit, when DC or AC drive signals are sequentially applied to both ends of at least one of the resistors, detects a location signal corresponding to the moving location using a signal from the cross conductor board in contact with the resistors.

32. The coordinate input device according to claim 30, wherein the location detection circuit applies DC or AC drive signals to the cross conductor board in contact with the resistors, and detects a location signal corresponding to the moving location using signals sequentially output from both ends of at least one of the resistors.

33. The coordinate input device according to claim 30, wherein the location detection circuit comprises an amplification circuit for amplifying signals from both ends of the resistors or the cross conductor board.

34. The coordinate input device according to claim 28, wherein, when a left, right or center of the lever is pressed, a click function including movement of a cursor, selection of content, scrolling, or provision or selection of a menu on a terminal is performed in conjunction with the terminal.

35. The coordinate input device according to claim 28, further comprising a keypad disposed on an upper surface of the lever or at a predetermined location in a casing in which the coordinate input device is mounted,
wherein the keypad comprises a plurality of keys for inputting predetermined key values to a terminal.

36. A coordinate input device comprising:
a lower plate combined with a circuit board including an optical sensor; and
an upper plate configured such that a protrusion is inserted into a guide recess or hole and is moved vertically or rotated laterally;
wherein the optical sensor detects a signal corresponding to a moving location of the upper plate while radiating light onto a lower surface of the upper plate through a through hole of the lower plate.

37. The coordinate input device according to claim 36, further comprising a cross conductor board disposed in contact with the parallel resistors formed on an upper surface of the circuit board and configured to be moved as the upper plate is moved vertically or rotated laterally,
wherein the protrusion is inserted into a guide recess or hole of the lower plate, and is then passed through and engaged with a central hole of the cross conductor board, and
wherein a drive signal is applied to the optical sensor, the cross conductor board or the parallel resistors and then a signal corresponding to a moving location of the upper plate is detected.

38. The coordinate input device according to claim 37, wherein:
a signal detected using the cross conductor board or the parallel resistor is used for correction of a signal detected using the optical sensor, and
a signal detected using the optical sensor is used for correction of a signal detected using the cross conductor board or the parallel resistor.

39. The coordinate input device according to claim 36, wherein, when a left, right or center of the upper plate is pressed, a click function including movement of a cursor, selection of content, scrolling, or provision or selection of a menu on a terminal is performed in conjunction with the terminal.

40. The coordinate input device according to claim 36, further comprising a keypad disposed on an upper surface of the upper plate or at a predetermined location in a casing in which the coordinate input device is mounted, and
wherein the keypad comprises a plurality of keys for inputting predetermined key values to a terminal.
